(19) United States
(12) Patent Application Publication
(10) Pub. No.: US 2007/0050640 A1
(43) Pub. Date: Mar. 1, 2007

(54) Information processing apparatus and authentication control method

(75) Inventor: Yoshio Matsuoka, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/508,906

(22) Filed: Aug. 24, 2006

(30) Foreign Application Priority Data
Aug. 31, 2005 (JP) 2005-252456

(51) Int. Cl. H04K 1/00

(52) U.S. Cl. 713/186

(57) ABSTRACT

According to one embodiment, an information processing apparatus includes a storage device that stores biological information to be used for identifying the user, a sensor that reads out biological information, a non-volatile memory that stores identification information for identifying the storage device, a first authentication section that executes an authentication process of verifying the authenticity of the user, using the biological information read out by the sensor and the biological information stored in the storage device, a verification section that verifies the authenticity of the storage device, using the identification information possessed by the storage device and the identification information stored in the non-volatile memory, and a boot section that executes a boot process of an operating system after the authentication by the first authentication section of the authenticity of the user and the verification by the verification section of the authenticity of the storage device.

### CROSS REFERENCE TO RELATED APPLICATIONS

This application is based upon and claims the benefit of priority from Japanese Patent Application No. 2005-252456, filed Aug. 31, 2005, the entire contents of which are incorporated herein by reference.

### BACKGROUND

1. Field

One embodiment of the invention relates to an information processing apparatus such as personal computer and, more particularly, it relates to an information processing apparatus having a user authentication feature and an authentication control method to be used in such an apparatus.

2. Description of the Related Art

Portable personal computers of a variety of different types have been developed in recent years such as the laptop type and the notebook type. These computers are equipped with a user authentication feature for preventing any unauthorized use of the computers.

The BIOS (basic input output system) password feature is known as a user authentication feature. With the BIOS password feature, the computer executes an authentication process in order to check the authenticity of the user when power is supplied to the computer. Unless the password input by the user by typing agrees with the BIOS password that is registered in the computer in advance, any operations including an operation of executing the boot up process of the computer system are prohibited. Thus, by providing the computer with the BIOS password feature, the computer is protected against any unauthorized use if the computer is stolen.

Meanwhile, Jpn. Pat. Appln. Publication No. 2002-183076 discloses a technique that can omit inputting by the user of a BIOS password by means an authentication process involving the use of biological information such as a fingerprint of the user for the purpose of simplification of user authentication.

For an authentication process involving the use of biological information, it is necessary to register the biological information in advance. In the case of a computer, a hard disk drive may be used for registering biological information. However, when the data on a fingerprint is stored on the hard disk drive and if the hard disk drive is switched by the hard disk drive of some other person, that other person can start the computer by using his or her fingerprint registered in the hard disk drive.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic perspective view of an information processing apparatus according to an embodiment of the present invention, showing the appearance thereof as viewed from the front side;

FIG. 2 is an exemplary schematic block diagram of the information processing apparatus of FIG. 1, showing the system configuration thereof;

FIG. 3 is an exemplary schematic illustration of the authentication feature that the information processing apparatus of FIG. 1 is equipped with according to the first embodiment of the present invention;

FIG. 4 is an exemplary schematic illustration of the system for executing a BIOS biological authentication process that the information processing apparatus of FIG. 1 is equipped with according to the first embodiment of the present invention;

FIG. 5 is an exemplary flowchart of the sequence of the process for registering the ID information stored in a hard disk drive in a non-volatile memory that is executed by the information processing apparatus of FIG. 1 according to the first embodiment of the present invention;

FIG. 6 is an exemplary flowchart of the sequence of the BIOS biological authentication process to be executed by the information processing apparatus of FIG. 1 according to the first embodiment of the present invention;

FIG. 7 is an exemplary schematic illustration of the system for executing a BIOS biological authentication process that the information processing apparatus of FIG. 1 is equipped with according to the second embodiment of the present invention;

FIG. 8 is an exemplary schematic illustration of a window that can be displayed by a fingerprint authentication utility according to the second embodiment of the present invention;

FIG. 9 is an exemplary schematic illustration of another window that can be displayed by a fingerprint authentication utility according to the second embodiment of the present invention;

FIG. 10 is an exemplary flowchart of the sequence of the process for generating a shared key and registering the generated shared key in a hard disk drive and a non-volatile memory to be executed by the information processing apparatus of FIG. 1 according to the second embodiment of the present invention; and

FIG. 11 is an exemplary flowchart of the sequence of the BIOS biological authentication process to be executed by the information processing apparatus of FIG. 1 according to the second embodiment of the present invention.

### DETAILED DESCRIPTION

Various embodiments according to the invention will be described hereinafter with reference to the accompanying drawings. In general, according to one embodiment of the invention, An information processing apparatus comprises a storage device that stores biological information to be used for identifying the user, a sensor that reads out biological information, a non-volatile memory that stores identification information for identifying the storage device, a first authentication section that executes an authentication process of verifying the authenticity of the user, using the biological information read out by the sensor and the biological information stored in the storage device, a verification section that verifies the authenticity of the storage device, using the identification information possessed by the storage device and the identification information stored in the non-volatile memory, and a boot section that executes a boot process of an operating system after the authentication by the first authentication section of the authenticity of the user and the verification by the verification section of the authenticity of the storage device.

### First Embodiment

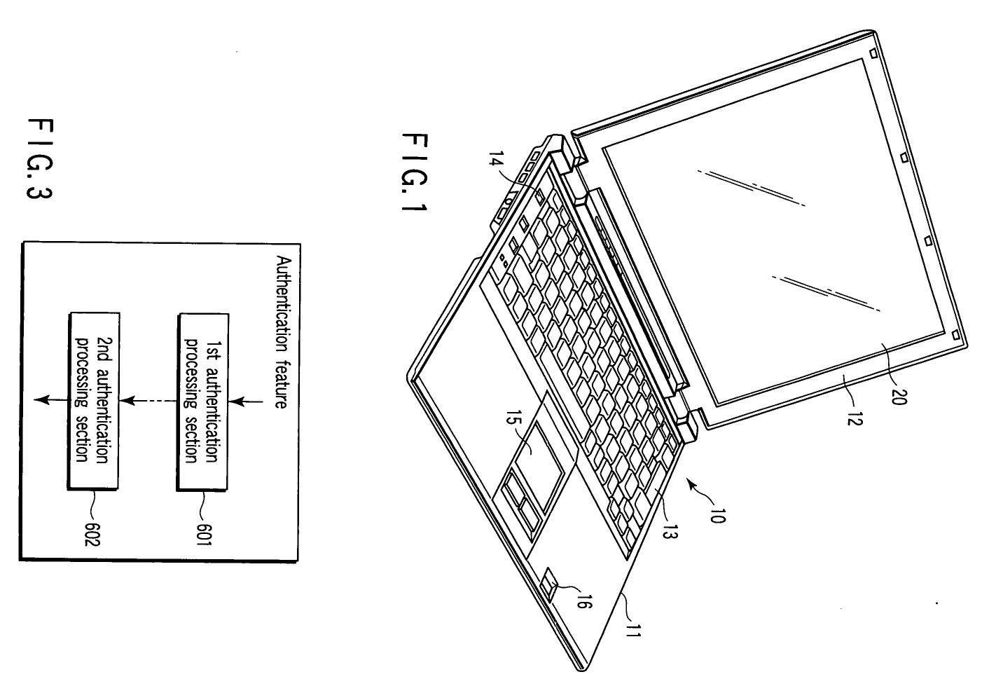

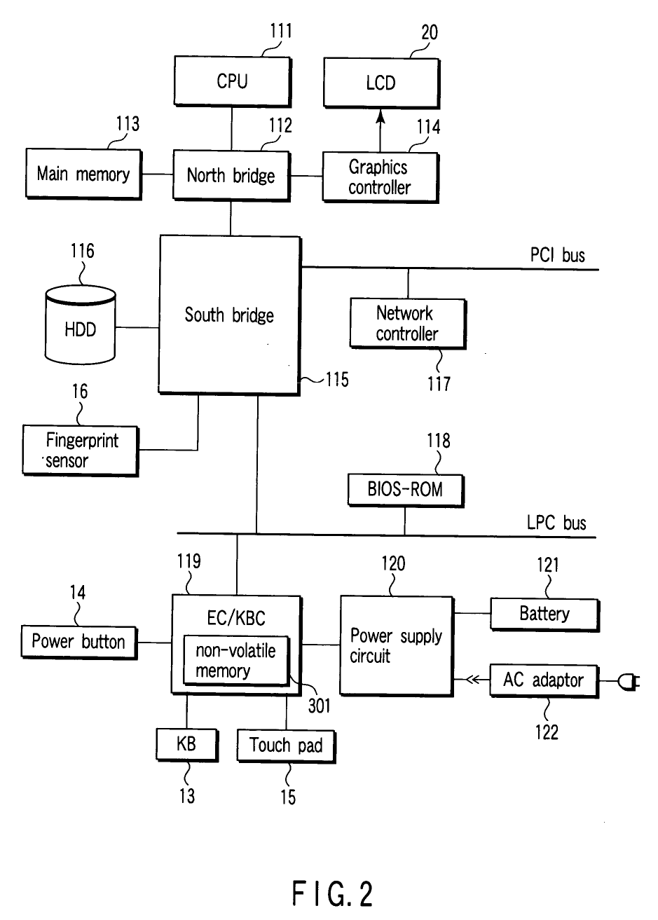

Firstly, the configuration of the information processing apparatus according to the first embodiment of the present invention will be described by referring to FIGS. 1 and 2. The information processing apparatus is realized as a notebook type portable personal computer 10 that can be driven to operate by a battery.

FIG. 1 is a schematic perspective view of the computer 10 with the display unit thereof in an opened state, as viewed from the front side thereof.

The computer 10 comprises a computer main body 11 and a display unit 12. A display apparatus having a liquid crystal display (LCD) 20 is incorporated in the display unit 12. The display screen of the LCD 20 is arranged substantially at the center of the display unit 12.

The display unit 12 is supported by the computer main body 11 and fitted to the latter in such a way that it can be rotated between an open position relative to the computer main body 11 where the top surface of the computer main body 11 is exposed and a closed position where it covers the top surface of the computer main body 11. The computer main body 11 has a thin box-shaped cabinet and a keyboard 13, a power button 14 for turning on/off the power supply to the computer 10 and a touch pad 15 are arranged on the top surface of the cabinet. Further, a fingerprint sensor 16 that reads the fingerprint of the user as biological information is arranged on the top surface of the computer main body 11.

FIG. 2 is a schematic block diagram of the computer 10 of FIG. 1, showing the system configuration thereof.

The computer 10 has a CPU 111, a north bridge 112, a main memory 113, a graphics controller 114, a south bridge 115, a hard disk drive (HDD) 116, a network controller 117, a flash BIOS-ROM 118, an embedded controller/keyboard controller IC (EC/KBC) 119, a power supply circuit 120 and so on.

The CPU 111 is a processor that controls the operation of each of the components of the computer 10. The CPU 111 executes the operating system and various application programs/utility programs loaded from the HDD 116 in the main memory 113. The CPU 111 also executes the system BIOS (basic input output system) stored in the BIOS-ROM 118. The system BIOS is a program for controlling hardware.

The north bridge 112 is a bridge device for connecting the local bus of the CPU 111 and the south bridge 115. The north bridge 112 has a function of executing communications with the graphics controller 114 typically by way of an AGP (accelerated graphics port) bus. A main controller that controls the main memory 113 is also contained in the north bridge 112.

The graphics controller 114 is a display controller for controlling the LCD 20 that is used as display monitor of the computer 10. The south bridge 115 is connected to a PCI (peripheral component interconnect) bus and an LPC (low pin count) bus.

The embedded controller/keyboard controller IC (EC/KBC) 119 is an 1-chip microcomputer where an embedded controller for managing the power supply and a keyboard controller for controlling the keyboard (KB) 13, the touch pad 15 and so on are integrally mounted. The embedded controller/keyboard controller IC 119 cooperates with the power supply circuit 120 to turn on/off the power supply of the computer 10 in response to an operation by the user of the power button 14. The power supply circuit 120 generates the system power to be supplied to each of the components of the computer 10 by using a battery 121 or the external power supplied to it by way of an AC adaptor 122. The EC/KBC 119 has a non-volatile memory 130 that can store various settings of the computer.

Now, the authentication feature that the computer 10 is equipped with will be described below by referring to FIG. 3.

A first authentication processing section (a second authentication section) 601 and a second authentication processing section (a third authentication section) 602 are mounted in the computer 10. The first authentication processing section 601 is adapted to execute a first authentication process for confirming the authenticity of the user in response to the power supplied to the computer 10.

The first authentication process is an authentication process to be executed before a system program such as an operating system is booted up. The first authentication process is typically realized by a BIOS authentication process to be executed by the system BIOS. When a user password is registered in the computer 10 in advance, the system BIOS requests the user to input the user password when power is supplied to the computer 10 to activate the latter. Then, the system BIOS determines if the user is the authentic user who is authorized to use the computer 10 by comparing the password that is input by the user by operating the keyboard 13 and the user password that is registered in advance. If it is determined that the user is the authentic user, the system BIOS permits a boot up process of the operating system and other processes to be executed. In other words, any operations of the computer 10 including execution of a boot up process are prohibited by the system BIOS until it is determined that the user is the authentic user of the computer 10. Thus, it is possible to protect the computer 10 against any unauthorized use of the computer 10 by the first authentication process if the computer is stolen.

The user password may also be referred to as BIOS password. The process of registering the user password is executed by the setup feature provided by the system BIOS or a dedicated utility program. The registered user password is stored in the BIOS-ROM 118 or in a non-volatile memory 130.

The second authentication processing section 602 executes a second authentication process to confirm the authenticity of the user after the execution of the first authentication process. The second authentication process is an authentication process to be executed after the successful completion of the first authentication process. The second authentication process is typically realized as a log on authentication process for determining if the user can log on (or log in) the operating system or not. The log on authentication process is executed by the operating system.

This apparatus can skip the first authentication process or the first authentication process and the second authentication process by a BIOS biological authentication process (a first authentication process). In the BIOS biological authentication process, the system BIOS compares the fingerprint that is registered in the computer 10 in advance and the fingerprint of the user input by the user by the fingerprint sensor 16 and determines the authenticity of the user according to the outcome of the comparison.

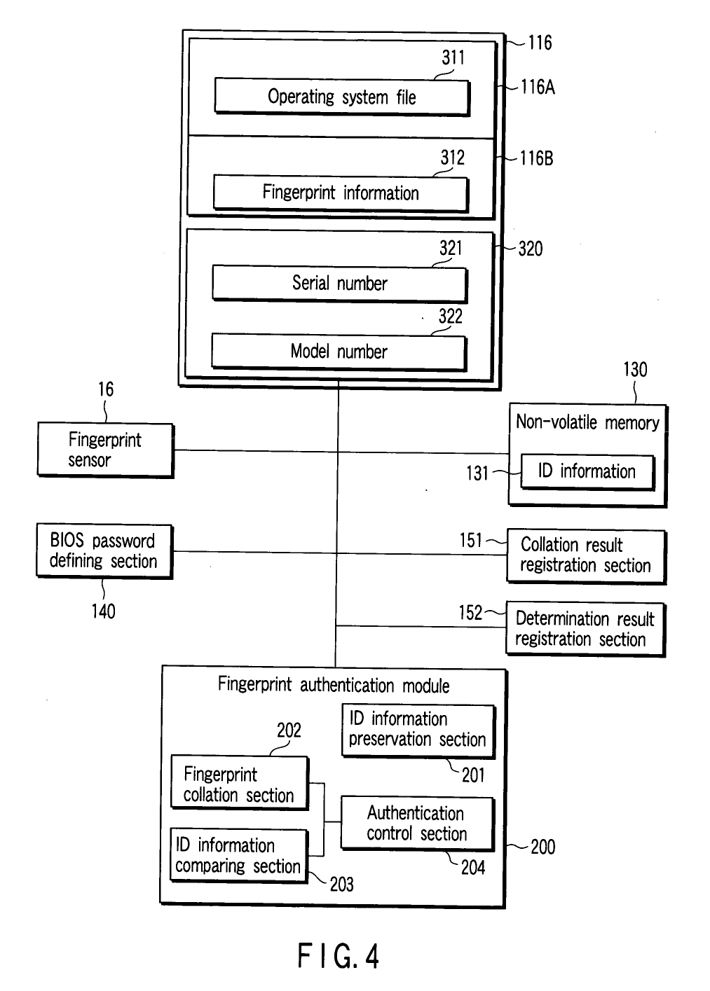

The system to be used for the BIOS biological authentication process will be described below by referring to the block diagram of FIG. 4.

Referring to FIG. 4, a BIOS password defining section 140 executes a process for defining a BIOS password. The BIOS password defined by the user is stored in the BIOS-ROM 118 or in the non-volatile memory 130.

ID information memory section 320 in the HDD 116, which may typically be a non-volatile memory, stores a serial number 321 that represents ID information and a model number 322 that represents the product name. The storage region of the HDD 116 has two regions including an ordinary partition 116A and a fingerprint authentication partition 116B. An operating system file 311 is stored in the ordinary partition 116A. The fingerprint information 312 that is read by the fingerprint sensor 16 and encrypted is registered in the fingerprint authentication partition 116B. The fingerprint authentication partition 116B where the fingerprint information 312 is registered is a hidden partition.

Fingerprint authentication module 200 is stored in the BIOS ROM 118 and loaded in the main memory 113 with the system BIOS when the computer is booted up. Then, it is executed by the CPU 111.

ID information preservation section 201 reads the serial number 321 and the model number 322 from the ID information memory section 320 and preserves them as ID information 131 in the non-volatile memory 130.

Fingerprint collating section 202 that operates as authentication section checks if the fingerprint information 312 preserved in the hard disk drive 116 and the user's fingerprint input from the fingerprint sensor 16 agree with each other or not and registers the outcome of the collation in collation result registration section 151 in the main memory 113.

ID information comparing section 203 that operates as verification section reads out the serial number 321 and the model number 322 from the hard disk drive 116 and determines if the serial number 321 and the model number 322 it reads out agrees with the ID information 131 stored in the non-volatile memory 130 or not. Then, it registers the outcome of the determining operation in comparison result registration section 152. The collation result registration section 151 and the comparison result registration section 152 are provided in the main memory 113 or in the non-volatile memory 130.

Authentication control section 204 reads out the contents of the collation result registration section 151 and those of the comparison result registration section 152 and executes a process corresponding to the outcome of the collation of the fingerprint collating section 202 and that of the comparison of the ID information comparing section 203.

Now, the flow of the process of reading the serial number 321 and the model number 322 from the hard disk drive 116 and storing it in the non-volatile memory 130 will be described below by referring to the flowchart of FIG. 5. This process is executed after the execution of the BIOS password defining process by the BIOS password defining section 140.

Firstly, the ID information preservation section 201 reads out the serial number 321 and the model number 322 from the ID information memory section 320 in the hard disk drive 116 (Step S11).

Then, the ID information preservation section 201 generates ID information on the basis of the serial number 321 and the model number 322 it reads out and preserves the ID information 131 in the non-volatile memory 130 (Step S12) before it ends the ID information preservation process.

The ID information 131 can be registered in the non-volatile memory 130 regardless if the fingerprint authentication partition 116B is provided or not. Thus, if the fingerprint authentication partition 116B is prepared, the fingerprint information 312 of the user may be registered in the fingerprint authentication partition 116B at any timing. More specifically, it may be registered before or after the registration of the ID information 131 in the non-volatile memory 130.

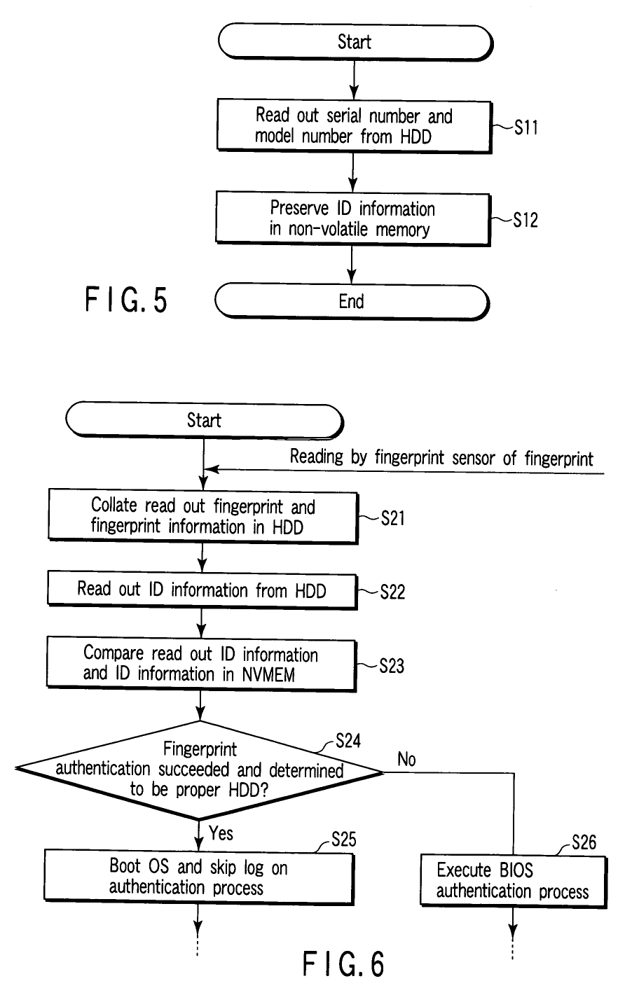

Now, the sequence of the BIOS biological authentication process will be described below by referring to the flowchart of FIG. 6.

As the fingerprint of the user is read out by the fingerprint sensor 16, the fingerprint collating section 202 collates the read out fingerprint and the fingerprint information 312 to determine if the read out fingerprint agrees with the fingerprint information 312 or not and then, it registers information on the success or failure of the fingerprint authentication in the collation result registration section 151 (Step S21).

The ID information comparing section 203 reads out the ID information including the serial number 321 and the model number 322 from the hard disk drive 116 (Step S22).

The ID information comparing section 203 then compares the ID information it reads out and the ID information 131 stored in the non-volatile memory (NVMEM) 130 and determines if the two pieces of ID information agree with each other or not. Then, it registers the outcome of the comparison in the comparison result registration section 152 (Step S23). Thus, in Step S23, it becomes clear if the hard disk drive contained in the main body is the one that was contained when the ID information of the hard disk drive was registered in the non-volatile memory 130 or not and hence if it is the proper hard disk drive or not.

The authentication control section 204 reads out the contents of the collation result registration section 151 and the comparison result registration section 152 and determines if the fingerprint authentication succeeded in Step S21 and the hard disk drive in the main body was determined to be the proper one in Step S23 or not (Step S24).

If the fingerprint authentication succeeded and the hard disk drive was determined to be the proper one (Step S24: Yes), the authentication control section 204 skips the BIOS authentication process and an operating system boot section contained in the system BIOS executes the boot process of the operating system. The authentication control section 204 skips the log on authentication process after the boot (Step S25). It may alternatively be so arranged that the authentication control section 204 skips only the BIOS authentication process and executes the log on process.

If, on the other hand, the fingerprint authentication failed and/or the hard disk drive was determined to be not the proper one (Step S24: No), the authentication control section 204 executes the BIOS authentication process (Step S26).

As a result of the above processes and due to the fingerprint data preserved in the hard disk drive 116 of the computer 10, the risk that the hard disk drive 116 is switched to some other hard disk drive and the computer 10 is started by the fingerprint of a person other than the authentic user stored in the some other hard disk drive is avoided.

While the two pieces of ID information are compared regardless of the outcome of the collation of the fingerprints in the above-described embodiment, it may alternatively be so arranged that the two pieces of ID information are not compared and the BIOS authentication process is executed when the two fingerprints are found to be not agreeing with each other as a result of the collation.

While the two pieces of ID information are compared after the collation of the fingerprints in the above-described embodiment, it may alternatively be so arranged that the fingerprints are collated after the comparison of the two pieces of ID information. Then, when the two pieces of ID information are found to be not agreeing with each other, the BIOS authentication process may be executed without executing the process of collating the two fingerprints.

Finally, while a fingerprint is used as biological information in the above-described embodiment, any other piece of biological information such as a palm print, an iris, a voice print or some other mark that can be used to identify a person may alternatively be used as biological information.

### Second Embodiment

A hard disk drive is recognized by utilizing ID information of the hard disk drive in the first embodiment. A shared key is generated by an application program that operates on the operating system of this embodiment to discriminate a hard disk drive. This embodiment will be described below.

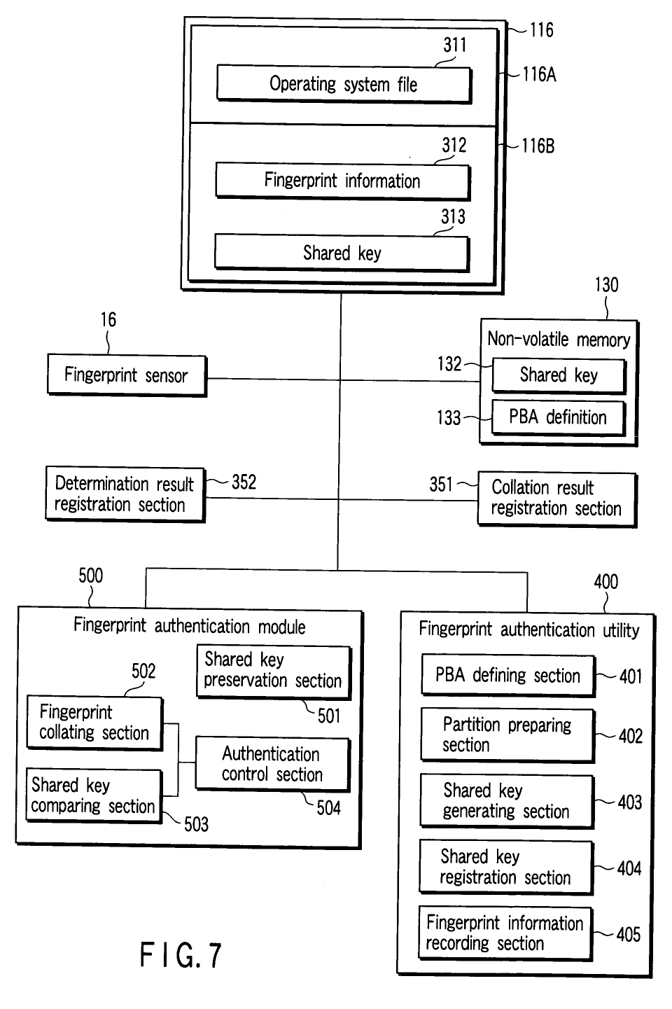

The system for generating a shared key and the system for executing a BIOS biological process authentication process of the second embodiment will be described below by referring to the block diagram of FIG. 7.

The preservation region of the HDD 116 has two regions including an ordinary partition 116A and a fingerprint authentication partition 116B. An operating system file 311 is stored in the ordinary partition 116A. The fingerprint information 312 that is read by the fingerprint sensor 16 and encrypted is stored in the fingerprint partition 116B. A shared key 313 is stored in the fingerprint authentication partition 116B. The fingerprint authentication partition 116B where the fingerprint information 312 and the shared key 313 are stored is a hidden partition.

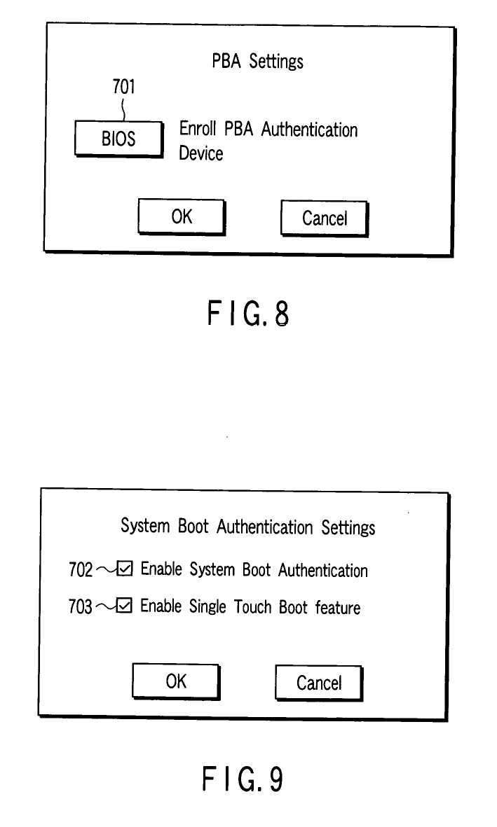

Fingerprint authentication utility 400 is an application program that operates on the operating system. The fingerprint authentication utility 400 displays a window as shown in FIG. 8. As the user operates button 701 by a pointer, a window as shown in FIG. 9 is displayed. As the check box 702 is enabled, it is possible to skip the BIOS authentication process by fingerprint authentication. As check box 703 is enabled, it is possible to skip the log on authentication process after a boot.

PBA defining section 401 preserves the contents defined by the window illustrated in FIG. 9 as PBA (pre-boot authentication) definition 133 in the non-volatile memory 130. Partition preparing section 402 prepares a fingerprint authentication partition 116B in the hard disk drive 116. Shared key generating section 403 generates a shared key. Shared key registration section 404 registers the shared key generated by the shared key generating section 403 in the fingerprint authentication partition 116B. After the partition preparing section 402 prepares the fingerprint authentication partition 116B, fingerprint information recording section 405 encrypts the fingerprint information read out by the fingerprint sensor 16 and preserves it in the fingerprint authentication partition 116B.

Fingerprint authentication module 500 is stored in the BIOS-ROM 118 and loaded in the main memory 113 with the system BIOS when the computer is started. Then, it is executed by the CPU 111.

Shared key preservation section 501 reads the shared key 313 from the fingerprint partition 116B and preserves it in the non-volatile memory 130 as shared key 132.

Fingerprint collating section 502 that operates as authentication section checks if the fingerprint information 312 preserved in the hard disk drive 116 and the user's fingerprint input from the fingerprint sensor 16 agree with each other or not and registers the outcome of the collation in collation result registration section 351 in the main memory 113.

Shared key comparing section 503 that operates as verification section reads out the shared key 313 from the fingerprint authentication partition 116B and determines if the shared key 313 it reads out agrees with the shared key 132 stored in the non-volatile memory 130 or not. Then, it registers the outcome of the determining operation in comparison result registration section 352. The collation result registration section 351 and the comparison result registration section 352 are provided in the main memory 113 or in the non-volatile memory 130.

Authentication control section 504 reads out the contents of the collation result registration section 351 and those of the comparison result registration section 352 and executes a process corresponding to the outcome of the collation of the fingerprint collating section 502 and that of the comparison of the shared key comparing section 503.

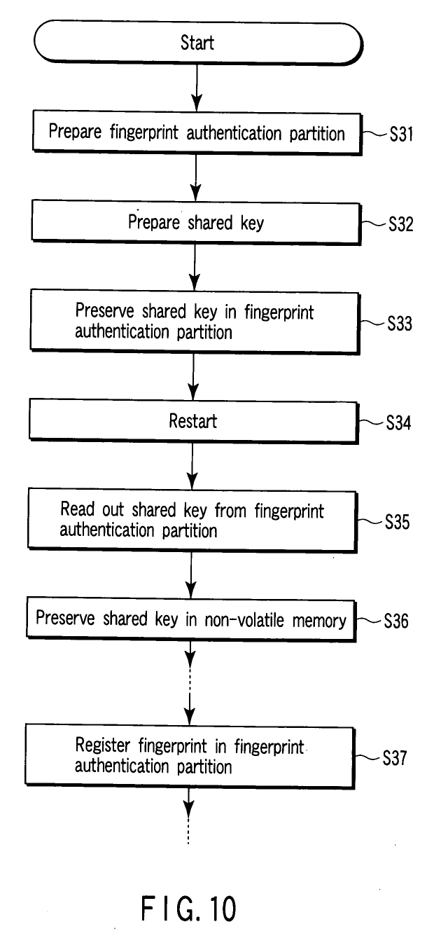

Now, the flow of the process of generating a shared key and registering the shared key generated in the non-volatile memory 130 will be described below by referring to the flowchart of FIG. 10.

The partition preparing section 402 prepares a fingerprint authentication partition 116B in the hard disk drive 116 (Step S31). The shared key generating section 403 randomly generates an integer value with a length of 64 bits for the purpose of generating a shared key (Step S32).

The shared key registration section 404 preserves the shared key 313 in the fingerprint authentication partition 116B (Step S33). The fingerprint authentication utility 400 restarts the operating system (Step S34).

The fingerprint authentication module 500 is executed when the system BIOS is executed. The shared key preservation section 501 reads out the shared key 313 from the fingerprint authentication partition 116B (Step S35). The shared key preservation section 501 then preserves the shared key 313 it reads out in the non-volatile memory 130 as shared key 132 (Step S36).

Subsequently, after the start of the operating system, the fingerprint information recording section 405 of the fingerprint authentication utility 400 registers the fingerprint information 312 in the fingerprint authentication partition 116B (Step S37).

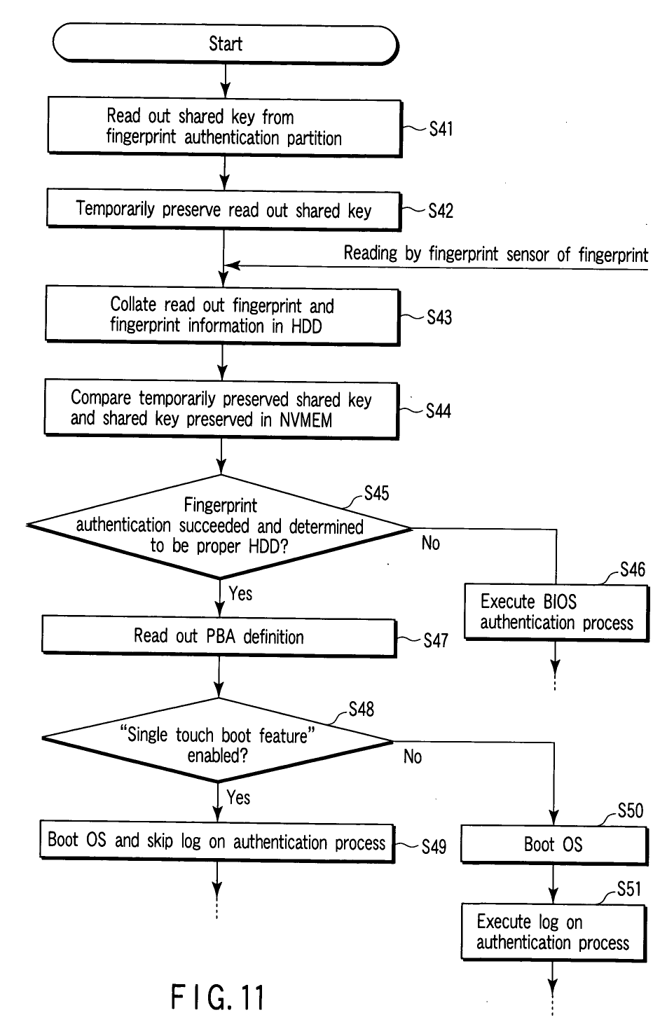

Now, the actual BIOS biological authentication process will be described by referring to the flowchart of FIG. 11.

As power is supplied to the computer 10, the fingerprint authentication module 500 is executed correspondingly. The shared key comparing section 503 of the fingerprint authentication module 500 reads out the shared key 313 from the fingerprint authentication partition 116B (Step S41). The shared key comparing section 503 temporarily stores the shared key 313 it reads out in the main memory 113 or the non-volatile memory 130 (Step S42).

As the fingerprint sensor 16 reads out a fingerprint of the user, the fingerprint collating section 502 collates the fingerprint information it reads out and the fingerprint information 312 stored in the fingerprint authentication partition 116B to determines if the read out fingerprint agrees with the fingerprint information 312 and then it registers information on the success or failure of the fingerprint authentication in the collation result registration section 351 (Step S43).

The shared key comparing section 503 compares the shared key 313 temporarily stored as a result of the processing operation in Step S42 and the shared key 132 preserved in the non-volatile memory (NVMEM) 130 to determine if the two shared keys 132, 313 agree with each other or not and then registers the outcome of the comparison in the comparison result registration section 352 (Step S44). Thus, in Step S44, it becomes clear if the hard disk drive contained in the main body is the one that was contained when the shared key was preserved in the non-volatile memory 130 or not and hence if it is the proper hard disk drive or not.

The authentication control section 504 reads out the contents of the collation result registration section 351 and the comparison result registration section 352 and determines if the fingerprint authentication succeeded in Step S43 and the hard disk drive in the main body was determined to be the proper one in Step S44 or not (Step S45).

If the fingerprint authentication failed and/or the hard disk drive was determined to be not the proper one (Step S45: No), the authentication control section 504 executes the BIOS authentication process (Step S46).

If, on the other hand, the fingerprint authentication succeeded and the hard disk drive was determined to be the proper one (Step S45: Yes), the authentication control section 504 reads out the PBA definition 133 (Step S47). The authentication control section 504 then determines if the “single touch boot feature” (as defined by the check box 703 in FIG. 9) is enabled or not (Step S48).

If the “single touch boot feature” is enabled (Step S48: Yes), the authentication control section 504 skips the BIOS authentication process and the operating system boot section contained in the system BIOS executes the boot process of the operating system. The authentication control section 504 skips the log on authentication process after the boot (Step S49).

If, on the other hand, the “single touch boot feature” is not enabled (Step S48: No), the authentication control section 504 skips the execution of the BIOS authentication process and the operating system boot section contained in the system BIOS executes the boot process of the operating system (OS) (Step S50). The operating system executes the log on authentication process (Step S51).

If the fingerprint authentication succeeded and the hard disk drive was determined to be the proper one (Step S24: Yes), the authentication control section 204 skips the BIOS authentication process and the operating system boot section contained in the system BIOS executes the boot process of the operating system. The authentication control section 204 skips the log on authentication process after the boot (Step S25). It may alternatively be so arranged that the authentication control section 204 skips only the BIOS authentication process and executes the log on process.

As a result of the above processes and due to the fingerprint preserved in the hard disk drive 116 of the computer 10, the risk that the hard disk drive 116 is switched to some other hard disk drive and the computer 10 is started by the fingerprint of a person other than the authentic user stored in the some other hard disk drive is avoided.

If the contents of the fingerprint authentication partition of some other computer are copied in the fingerprint authentication partition 116, the shared key stored in the non-volatile memory 130 and the shared key stored in the fingerprint authentication partition differ from each other so that any attempt for starting the computer by a fingerprint of some other person is suppressed.

While the shared keys are compared regardless of the outcome of the collation of fingerprints in the above-described embodiment, it may alternatively be so arranged that the shared keys are not compared and the BIOS authentication process is executed when the outcome of the collation of fingerprints proves that the fingerprints do not agree with each other.

While the two shared keys are compared after the collation of the fingerprints in the above-described embodiment, it may alternatively be so arranged that the fingerprints are collated after the comparison of the two shared keys. Then, when the two shared keys are found to be not agreeing with each other, the BIOS authentication process may be executed without executing the process of collating the two fingerprints.

Finally, while a fingerprint is used as biological information in the above-described embodiment, any other piece of biological information such as a palm print, an iris, a voice print or some other mark that can be used to identify a person may alternatively be used as biological information.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a storage device that stores biological information to be used for identifying the user;
a sensor that reads out biological information;
a non-volatile memory that stores identification information for identifying the storage device;
a first authentication section that executes an authentication process of verifying the authenticity of the user, using the biological information read out by the sensor and the biological information stored in the storage device;
a verification section that verifies the authenticity of the storage device, using the identification information possessed by the storage device and the identification information stored in the non-volatile memory; and
a boot section that executes a boot process of an operating system after the authentication by the first authentication section of the authenticity of the user and the verification by the verification section of the authenticity of the storage device.

2. The information processing apparatus according to claim 1, further comprising:
a second authentication section that executes a second authentication process of verifying the authenticity of the user by a basic input output system (BIOS) after the execution by the first authentication section of the authentication process; and
an authentication control section that skips the execution by the second authentication section of the second authentication process upon the authentication by the first authentication section of the authenticity of the user and the verification by the verification section of the authenticity of the storage device.

3. The information processing apparatus according to claim 1, further comprising:
a second authentication section that executes a second authentication process of verifying the authenticity of the user by a basic input output system (BIOS) after the execution by the first authentication section of the authentication process;
a third authentication section that executes a third authentication process of verifying the user as user authorized to log on the operating system after the execution of a process of staring the operating system; and
an authentication control section that skips the execution of the second authentication process and the execution of the third authentication process upon the authentication by the first authentication section of the authenticity of the user and the verification by the verification section of the authenticity of the storage device.

4. The information processing apparatus according to claim 1, further comprising:
a second authentication section that executes a second authentication process of verifying the authenticity of the user by a basic input output system (BIOS) upon non-verification by the first authentication section of the authenticity of the user.

5. The information processing apparatus according to claim 1, wherein
the identification information possessed by the storage device is ID information of the storage device;
the information processing apparatus further comprising:
a preservation section that preserves the ID information in the non-volatile memory as identification information to be stored in the non-volatile memory.

6. The information processing apparatus according to claim 1, further comprising:
an application program that generates the identification information and preserves the generated identification information in the storage device; and
a preservation section that preserves the generated identification information preserved in the storage device in the non-volatile memory.

7. The information processing apparatus according to claim 1, wherein the storage device is a hard disk drive.

8. An information processing apparatus comprising:
a storage device that stores biological information to be used for identifying the user;
a sensor that reads out biological information;
a non-volatile memory that stores identification information for identifying the storage device;
a first authentication section that executes a first authentication process of verifying the authenticity of the user, using the biological information read out by the sensor and the biological information stored in the storage device;
a verification section that verifies the authenticity of the storage device, using the identification information possessed by the storage device and the identification information stored in the non-volatile memory; and
a second authentication section that executes a second authentication process of verifying the authenticity of the user by a basic input output system (BIOS) after the execution by the first authentication section of the first authentication process.

9. The information processing apparatus according to claim 8, further comprising:
an authentication control section that skips the execution of the second authentication process upon the authentication by the first authentication section of the authenticity of the user and the verification by the verification section of the authenticity of the storage device.

10. The information processing apparatus according to claim 8, further comprising:
a third authentication section that executes a third authentication process of verifying the user as user authorized to log on an operating system after the execution of boot the operating system; and
an authentication control section that skips the execution of the second authentication process and the execution of the third authentication process upon the authentication by the first authentication section of the authenticity of the user and the verification by the verification section of the authenticity of the storage device.

11. The information processing apparatus according to claim 8, wherein the second authentication section executes the second authentication process upon non-verification by the first authentication section of the authenticity of the user.

12. An authentication control method for limiting users using an information processing apparatus, the method comprising:
preserving the biological information of a user read out by sensor in a storage device;
preserving the identification information possessed by the storage device in a non-volatile memory;
reading biological information of the user by the sensor;
verifying the authenticity of the user, using the biological information read out by the sensor and the biological information preserved in the storage device;
verifying the authenticity of the storage device, using the identification information possessed by the storage device and the identification information stored in the non-volatile memory; and
executing a process of boot an operating system upon authentication of the authenticity of the user and verification of the authenticity of the storage device.

13. The authentication control method according to claim 12, wherein
the information processing apparatus comprises a second authentication section that executes a second authentication process of verifying the authenticity of the user by a basic input output system (BIOS) after the execution of the authentication process, and
the method further includes skipping the execution of the second authentication process upon the authentication of the authenticity of the user and the verification of the authenticity of the storage device.

14. The method according to claim 12, wherein
the information processing apparatus comprises a second authentication section that executes a second authentication process of verifying the authenticity of the user by a basic input output system (BIOS) after the execution of the authentication process by the authentication section and a third authentication section that executes a third authentication process of verifying the user as user authorized to log on the operating system after the execution of a process of boot the operating system; and
the method further includes skipping the execution of the second authentication process and the execution of the third authentication process upon the authentication of the authenticity of the user and the verification of the authenticity of the storage device.

15. The authentication control method according to claim 12, further comprising: executing the second authentication process of verifying the authenticity of the user by a basic input optical system (BIOS) upon non-verification by the authentication section of the authenticity of the user.

16. The authentication control method according to claim 12, further comprising:
reading out the ID information possessed by the storage device; and
storing the ID information in the non-volatile memory as the identification information.

17. The authentication control method according to claim 12, further comprising:
generating the identification information; and
preserving the generated identification information in the storage device, wherein
the preservation of identification information in the non-volatile memory is preservation of the identification information preserved in the storage device in the non-volatile memory.
